(19) United States
(12) Patent Application Publication
(10) Pub. No.: US 2025/0162444 A1
(43) Pub. Date: May 22, 2025

(54) METHOD AND SYSTEM FOR CONTROLLING CHARGING OF ELECTRIC VEHICLE

(71) Applicant: Hyundai Kefico Corporation, Gunpo, Gyeonggi-Do (KR)

(72) Inventor: So-Hyun Jang, Suwon (KR)

(21) Appl. No.: 18/949,198

(22) Filed: Nov. 15, 2024

(30) Foreign Application Priority Data
Nov. 16, 2023 (KR) 10-2023-0159019

(51) Int. Cl. B60L 53/66; B60L 53/18; B60L 53/62

(52) U.S. Cl. CPC B60L 53/66; B60L 53/18; B60L 53/62

(57) ABSTRACT

A method for controlling charging of an electric vehicle is configured to monitor noise in a communication line in real time so as to control a charging current/voltage level, in order to prevent communication from being interrupted due to the noise. The method includes, upon connecting an external charger and the electric vehicle, identifying a charging control mode based on charging power from the external charger and noise; generating target power information based on the identified charging control mode; and transmitting the generated target power information to the external charger, which steps are configured to be performed by a control unit of the electric vehicle.

### CROSS REFERENCE TO RELATED APPLICATION

The present application claims under 35 U.S.C. § 119 (a) the benefit of Korean Patent Application No. 10-2023-0159019, filed Nov. 16, 2023, the entire contents of which are incorporated by reference herein.

### BACKGROUND

### (a) Technical Field

The present disclosure relates to controlling charging of an electric vehicle, more particularly, to a method and system of controlling charging in which noise in a communication line is monitored in real time to control a charging current/voltage level, thereby preventing communication from being interrupted due to the noise.

### (b) Description of the Related Art

A method of charging a battery is divided into a fast charging method using a separate, external charger, and a slow charging method using a charger mounted to an electric vehicle.

In the case of the slow charging method, an on-board charger (OBC) is connected to a slow charging port and converts household AC power into DC power, thereby charging the battery. The OBC uses electric vehicle supply equipment (EVSE) to receive electricity, in which the EVSE checks a level of a control pilot (CP) voltage when receiving the electricity, thereby identifying whether to charge the battery.

A general charging method for an electric vehicle is based on power line communication (PLC) using a CP line. The battery is charged under control of constant current and constant voltage.

In this case, high charging current and voltage cause electrostatic induction (due to the voltage of the power line, which is more largely affected as the voltage becomes higher), and electromagnetic induction (due to the current of the power line), and thus generate noise in the power line, thereby interrupting the communication and leading to a problem of interrupting the charging.

### SUMMARY

The present disclosure provides a constant-noise charging control method by which noise in a communication line is monitored in real time to control a charging current/voltage level, thereby preventing communication from being interrupted due to the noise.

Another aspect of the disclosure is to provide a charging control method by which a level of communication noise is controlled not to exceed a reference level and communication is thus prevented from being interrupted during charging, thereby performing the charging efficiently without interruption.

To solve the foregoing problems, the disclosure provides a constant noise charging control method of controlling charging current/voltage level to prevent communication from being interrupted due to noise by monitoring noise in a communication line in real time.

The method includes: connecting an external charger and the electric vehicle; identifying charging control modes based on charging power from the external charger and noise, by a control unit of the electric vehicle; and generating target power information based on the identified charging control mode and transmitting the generated target power information to the external charger, by the control unit.

In an aspect, the method includes: upon connecting the electric vehicle to an external charger, identifying, by a control unit of the electric vehicle, a charging control mode based on charging power from the external charger and noise; and generating, by the control unit, target power information based on the identified charging control mode; and transmitting, by the control unit, the generated target power information to the external charger, by the control unit.

Further, the identification of the charging control mode may include: comparing a current noise, a current voltage and a current with a preset reference noise, a preset reference voltage, a preset reference current, respectively, by an identification module; identifying a constant current (CC) control mode, a constant noise (CN) control mode, or a constant voltage (CV) control mode among a plurality of charging control modes based on the comparison, by the identification module; and generating a reference command based on the identified CC, CN, or CV control mode, by the identification module.

Further, the CC control mode may include control that performs charging with a stepwise constant current, the CN control mode may include control that performs charging while decreasing a charging current and maintaining a constant noise level, and the CV control mode may include control that performs charging while maintaining a constant voltage.

Further, the identification module may identify the CC control mode upon the current noise more than the reference noise and the current voltage lower than the reference voltage, identify the CN control mode upon the current noise more than or equal to the reference noise and the current voltage lower than the reference voltage, and identify the CV control mode upon the current voltage higher than or equal to the reference voltage.

Further, the transmission of the target power information may include, by an execution module (of the control unit), increasing current at a certain rate based on a reference current command in the case of the CC control mode to generate target current information.

Further, the transmission of the target power information may include, by an execution module (of the control unit), subtracting a current noise level from a reference noise command and controlling noise through a proportional-integral (PI) controller in the CN control mode to generate target current information.

Further, the transmission of the target power information may include, by an execution module (of the control unit), setting a reference voltage of a reference voltage command as a target voltage to generate target voltage information.

Further, the preset levels of the reference noise, the reference voltage, and the reference current may be set and stored in the control unit in advance.

Further, the control unit may operate in the CV control mode upon a current battery voltage reaching the reference voltage as the charging progresses.

Further, communication between the external charger and the electric vehicle may include power line communication (PLC).

Further, the method may further include, by the external charger, charging the electric vehicle based on the target power information.

A charging control system for an electric vehicle includes: the electric vehicle comprising an inlet for connecting to an external charger; and a control unit operable to: identify a charging control mode based on charging power from the external charger and noise; generate target power information based on the identified charging control mode; and transmit the generated target power information to the external charger.

A vehicle may include the above-described charging control system.

### BRIEF DESCRIPTION OF THE DRAWINGS

FIG. 1 is a block diagram of a charging control system according to an embodiment of the disclosure.

FIG. 2 is a conceptual diagram of a standard cable for general DC fast charging.

FIG. 3 is a waveform diagram showing a control pilot (CP) signal waveform according to an embodiment of the disclosure.

FIG. 4 is a block diagram showing a detailed configuration of a control unit shown in FIG. 1.

FIG. 5 is a flowchart showing a charging control process according to an embodiment of the disclosure.

FIG. 6 shows general constant current (CC)/constant voltage (CV) charging profiles.

FIG. 7 shows constant current (CC)/constant noise (CN)/constant voltage (CV) charging profiles according to an embodiment of the disclosure.

FIG. 8 shows general charging profiles and charging profiles according to an embodiment of the disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The foregoing purposes, features, and advantages will be described later in detail with reference to the accompanying drawings, and thus a person having ordinary knowledge in the art to which the disclosure pertains can easily implement the scope and spirit of the disclosure. In terms of describing the disclosure, if it is determined that detailed descriptions of publicly known technologies associated with the disclosure may blurs the gist of the disclosure, the detailed descriptions thereof will be omitted. Hereinafter, a method of controlling charging of an electric vehicle according to an embodiment of the disclosure will be described in detail with reference to the accompanying drawings. Throughout the accompanying drawings, the same numerals refer to the same or similar elements.

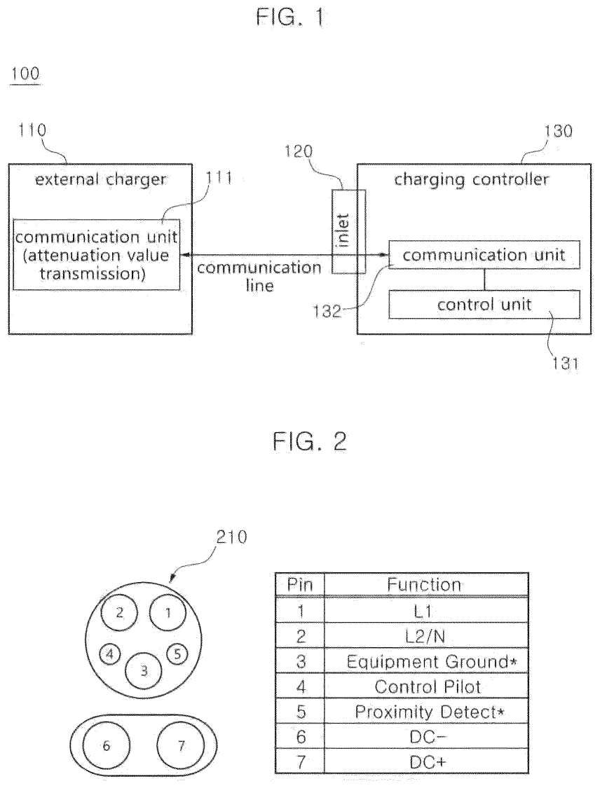

FIG. 1 is a block diagram of a charging control system 100 according to an embodiment of the disclosure. Referring to FIG. 1, the charging control system 100 may include an external charger 110 providing charging power, and an electric vehicle 130 configured to be connected to the external charger 110 through a power cable and receiving the charging power.

The external charger 110 may generally employ electric vehicle supply equipment (EVSE), but may use other charging devices such as an ultra-fast charger.

The external charger 110 may include a controller (not shown), a communication unit 111. The controller may include a microcomputer, a microprocessor, a memory, etc. The controller performs the functions of the external charger 110. The memory may include at least one type of storage medium among a flash memory type, a hard disk type, a multimedia card micro type, a card type memory (e.g., a secure digital (SD) or extreme Digital (XD) memory, etc.), a random access memory (RAM), a static random access memory (SRAM), a read only memory (ROM), an electrically erasable programmable read only memory (EEPROM), a programmable read only memory (PROM), a magnetic memory, a magnetic disk, and an optical disk. Further, the memory may operate in connection with a web storage and a cloud server, which perform storage functions on the Internet.

The communication unit 111 transmits an attenuation value generated by the controller. To this end, the communication unit 111 may include a communication modem, a microprocessor, a communication circuit, etc.

The communication unit 111 is connected to the electric vehicle 130 through a communication line. The communication line may include a control pilot (CP) line. The communication unit 111 performs transmission and reception using power line communication (PLC) with the electric vehicle 130 through the CP line.

On the side of the electric vehicle 130, an inlet 120 is provided. By inserting a cable connector (not shown) into the inlet 120, the electric vehicle 130 is connected to the external charger 110.

The electric vehicle 130 also includes a control unit 131 and a communication unit 132. The control unit 131 transmits target voltage/current information to the external charger 110 through the communication unit 132. The control unit 131 and the communication unit 132 are components of a charging controller which is installed in the electric vehicle 130.

The control unit 131 may receive and execute command from a driver, or may provide information to the driver through a display (not shown). To this end, the control unit 13 may include a microcomputer, a microprocessor, a memory, etc.

The communication unit 132 may include a communication modem, a microprocessor, a communication circuit, etc.

FIG. 2 is a conceptual diagram of a standard cable for general DC fast charging. Referring to FIG. 2, the inlet 120 includes first to seventh pins when viewed from the front. The functions for those pins are defined to use the first pin for L1, the second pin 2 for L2/N, the third pin for the equipment ground, the fourth pin for control pilot (CP), the fifth pin is for proximity detection, the sixth pin for DC−, and the seventh pin for DC+.

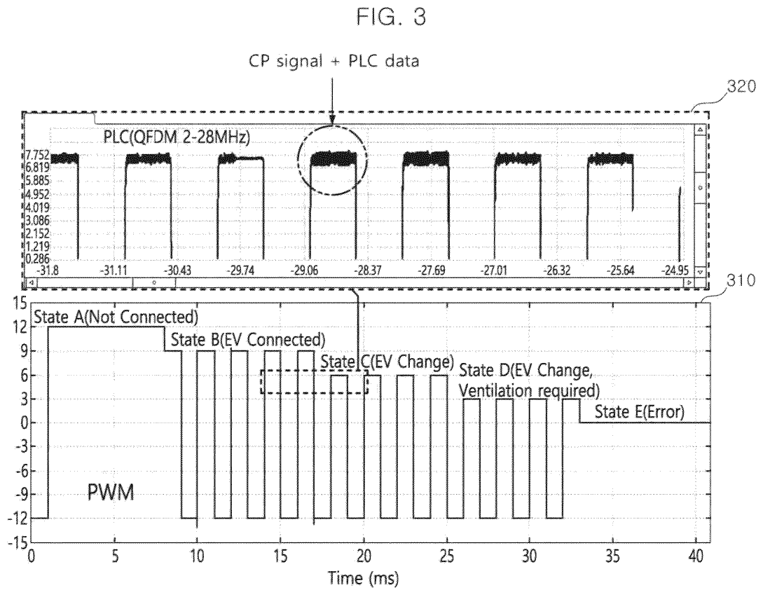

FIG. 3 is a waveform diagram showing a CP signal waveform according to an embodiment of the disclosure. Referring to FIG. 3, noise is generally caused by electrostatic induction (i.e., due to voltage in a power line) and electromagnetic induction (i.e., due to current in the power line) when charging is performed between the external charger 110 and the electric vehicle 130, thereby interrupting communication and stopping charging. In other words, when a noise level is greater than or equal to a reference level, the communication is interrupted and the charging is stopped.

To solve this, according to an embodiment of the disclosure, the current/voltage is controlled based on feedback on noise in the CP line, thereby controlling a noise level not to exceed a certain level.

The lower graph 310 shows a CP waveform, and the upper graph 320 shows a waveform of a CP signal added with PLC data.

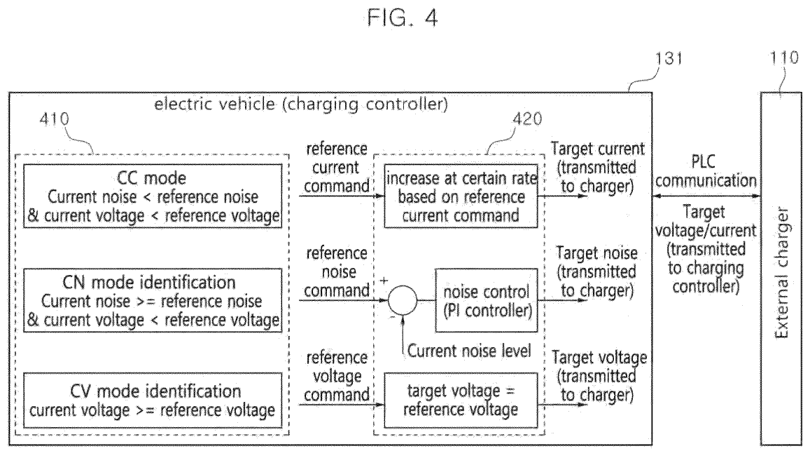

FIG. 4 is a block diagram showing a detailed configuration of a control unit 131 shown in FIG. 1. Referring to FIG. 4, the control unit 131 may include an identification module 410 that identifies a charging control mode, and an execution module 420 that generates target power based on the charging control mode.

The identification module 410 compares the set reference current, noise and voltage with the current, noise, and voltage currently introduced from the external charger 110 to identify the charging control mode, and generates a reference command based on the identified charging control mode.

The charging control mode includes a constant current (CC) control mode, a constant noise (CN) control mode, a constant voltage (CV) control mode.

In the CC control mode, charging is controlled with a stepwise constant current. A current, the battery voltage increases and then the noise increases. In addition, when the current noise is less than the reference noise and the current voltage is lower than the reference voltage, the identification module 410 identifies the CC control mode. In this case, a reference current command is generated.

The CN control mode is performed when the battery noise is more than the reference level. That is, the CN control mode refers to control performed to maintain the charging at a constant noise level while decreasing the charging current. In addition, when the current noise is more than the reference noise and the current voltage is lower than the reference voltage, the identification module 410 identifies the CN control mode. In this case, a reference noise command is generated.

The CV control mode is performed when the battery voltage reaches a certain voltage while the battery is being charged. That is, the CV control mode refers to control performed to maintain the charging at a constant voltage. In addition, when the current voltage is higher than the reference voltage, the CV control mode is identified. In this case, a reference voltage command is generated.

The execution module 420 performs a function of generating target power information based on the identified charging control mode.

The execution module 420 performs a function of generating a target power command based on the reference current command, the reference noise command, and the reference voltage command generated by the identification module 410.

In the case of the CC control mode, target current information is generated by increasing the current at a certain rate based on the reference current command. Because the battery voltage at initial charging is lower than the reference voltage, the CC control mode operates. In this case, when the charging is performed with a high current, the noise increases more than the reference noise, thereby interrupting the communication.

To prevent this, a target current is increased from the reference current at a certain rate. For example, the target current=the reference current*0.1, *0.2, *0.3 . . .

The external charger 110 receives the target current information through the PLC and charges the battery in the CC control mode.

Referring to FIG. 4, in the case of the CN control mode, a current noise level is subtracted from the reference noise command, and noise is controlled by a proportional-integral (PI) controller to generate the target current information. When the charging current and/or voltage of the battery increases while CC charging is performed with the target current, the current noise increases.

When the current noise is more than or equal to the reference noise, the noise control is performed to control the target current. Because the charging voltage increases as the charging progresses, the output (i.e., the target current) of the noise control for maintaining the reference noise decreases gradually. The external charger 110 charges the battery with the target current received through the PLC.

In the case of the CV control mode, the reference voltage is set as the target voltage to generate target voltage information. When the current battery voltage reaches the reference voltage as the charging progresses, the CV control mode operates. The target voltage becomes the reference voltage, and the external charger charges the battery in the CV control mode with the target voltage received through the PLC.

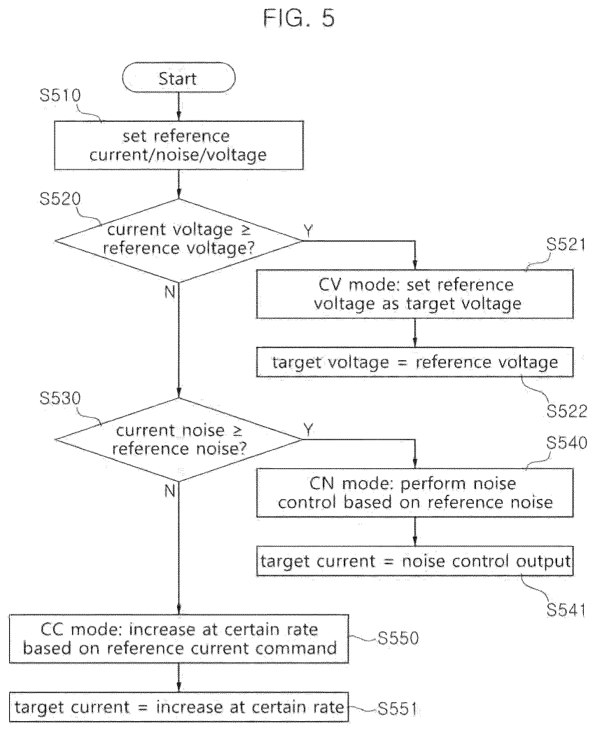

FIG. 5 is a flowchart showing a charging control process according to an embodiment of the disclosure. Referring to FIG. 5, a driver first sets a reference current, a reference noise, and a reference voltage through an input unit in an electric vehicle (S510). The input unit may include a touch screen, a microphone, etc.

Then, when the external charger 110 and the electric vehicle 130 are connected, the control unit 131 identifies whether the current voltage from the external charger 110 is higher than or equal to the reference voltage (S520).

When it is identified in the step S520 that the current voltage is higher than or equal to the reference voltage, the control unit 131 enters the CV control mode to set the target voltage as the reference voltage (S521 and S522).

On the other hand, when it is identified in the step S520 that the current voltage is lower than the reference voltage, the control unit 131 identifies whether the current noise is more than or equal to the reference noise (S530).

When it is identified in the step S530 that the current noise is more than or equal to the reference noise, the control unit 131 enters the CN control mode to perform the noise control based on the reference noise, and sets the target current as noise control output (S540 and S541).

When it is identified in the step S530 that the current noise is less than the reference noise, the control unit 131 enters the CC control mode to increase the target current at a certain rate based on the reference current command (S550 and S551).

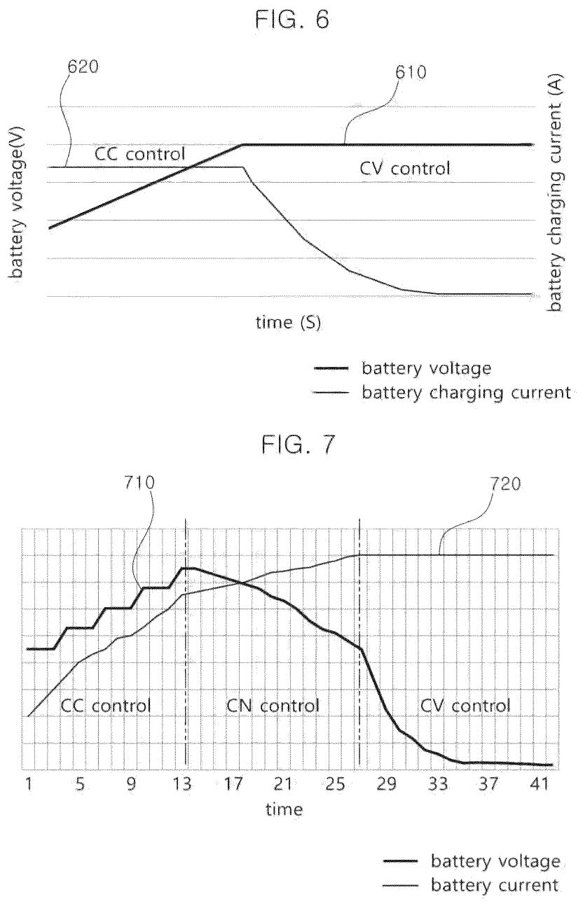

FIG. 6 shows general CC/CV charging profiles. Referring to FIG. 6, a battery charging current 620 is constant in the section of the CC control mode and decreases in the section of the CV control mode. Meanwhile, a battery voltage 610 increases steadily in the section of the CC control mode and is constant in the section of the CV control mode.

FIG. 7 shows CC/CN/CV charging profiles according to an embodiment of the disclosure. Referring to FIG. 7, unlike FIG. 6, a CN control mode is provided between the CC control mode and the CV control mode. A battery current 710 increases stepwise in the section of the CC control mode, decreases steadily in the section of the CN control mode, and suddenly decreases and converges approximately to zero in the section of the CVD control mode.

Meanwhile, a battery voltage 720 increases in the sections of the CC control mode and the CN control mode, and is constant as a smooth line in the section of the CV control mode.

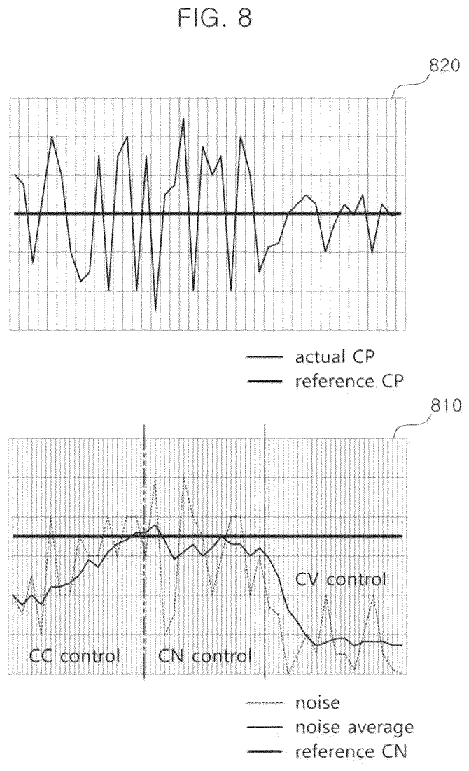

FIG. 8 shows general charging profiles and charging profiles according to an embodiment of the disclosure. Referring to FIG. 8, an upper graph 820 shows an actual CP and a reference CP. The lower graph 810 shows noise, noise average and reference CN in the sections of the CC control mode, the CN control mode, and the CV control mode.

Further, the steps of the method or algorithm described in relation to the embodiments disclosed herein may be implemented in the form of program instructions to be executable through various computer means such as a microprocessor, a processor, and a central processing unit (CPU), and recorded in a computer readable medium. The computer readable medium may include a program (instruction) code, a data file, a data structure, etc. alone or in combination.

The program (instruction) code recorded in the medium may be specially designed and configured for the disclosure, or may be known and usable to those skilled in the art of computer software. For example, the computer readable recording medium may include magnetic media such as hard disk drives, floppy disk drives, and magnetic tapes; optical media such as compact disc read only memory (CD-ROM), digital versatile discs (DVD), and Blue-ray discs; and semiconductor memory devices particularly configured to store and execute the program (instruction) codes, such as read only memories (ROM), random access memories (RAM), and a flash memory.

Here, examples of the program (instruction) code include not only a machine language code created by a compiler, but also a high-level language code executable by a computer using an interpreter or the like. The foregoing hardware devices may be configured to operate as one or more software modules to perform the operations of the disclosure, and vice versa.

The disclosure has an effect on performing the constant noise (CN) charging, in which the noise of the CP line is monitored in real time and the charging current/voltage is controlled to prevent the communication from being interrupted due to the noise.

Further, the disclosure has another effect on performing the charging efficiently without interruption as the level of communication noise is controlled not to exceed the reference level and the communication is thus prevented from being interrupted during charging.

What is claimed is:

1. A method of controlling charging of an electric vehicle, the method comprising:
upon connecting the electric vehicle to an external charger, identifying, by a control unit of the electric vehicle, a charging control mode based on charging power from the external charger and noise; and
generating, by the control unit, target power information based on the identified charging control mode; and
transmitting, by the control unit, the generated target power information to the external charger, by the control unit.

2. The method of claim 1, further comprising connecting the electric vehicle to the external charger through a power cable.

3. The method of claim 1, wherein the control unit comprises an identification module configured to identify the charging control mode, and an execution module configured to generate target power based on the charging control mode.

4. The method of claim 1, wherein the charging control mode is identified among a plurality of charging control modes.

5. The method of claim 1, wherein identifying the charging control mode comprises:
comparing a current noise, a current voltage and a current with a preset reference noise, a preset reference voltage, a preset reference current, respectively, by an identification module;
identifying a constant current (CC) control mode, a constant noise (CN) control mode, or a constant voltage (CV) control mode among a plurality of charging control modes based on the comparison, by the identification module; and
generating a reference command based on the identified CC, CN, or CV control mode, by the identification module.

6. The method of claim 5, wherein the CC control mode comprises control that performs charging with a stepwise constant current, the CN control mode comprises control that performs charging while decreasing a charging current and maintaining a constant noise level, and the CV control mode comprises control that performs charging while maintaining a constant voltage.

7. The method of claim 5, wherein the identification module identifies the CC control mode upon the current noise more than the reference noise and the current voltage lower than the reference voltage, identifies the CN control mode upon the current noise more than or equal to the reference noise and the current voltage lower than the reference voltage, and identifies the CV control mode upon the current voltage higher than or equal to the reference voltage.

8. The method of claim 5, wherein transmitting the target power information comprises increasing, by the control unit, current at a certain rate based on a reference current command in the case of the CC control mode to generate target current information.

9. The method of claim 5, wherein transmitting the target power information comprises subtracting, by the control unit, a current noise level from a reference noise command and controlling noise through a proportional-integral (PI) controller in the CN control mode to generate target current information.

10. The method of claim 5, wherein the transmission of the target power information comprises setting, by the control unit, a reference voltage of a reference voltage command as a target voltage to generate target voltage information.

11. The method of claim 5, wherein the preset levels of the reference noise, the reference voltage, and the reference current are set and stored in the control unit in advance.

12. The method of claim 5, wherein the control unit operates in the CV control mode upon a current battery voltage reaching the reference voltage as the charging progresses.

13. The method of claim 1, wherein communication between the external charger and the electric vehicle comprises power line communication (PLC).

14. The method of claim 1, further comprising charging the electric vehicle based on the target power information.

15. A charging control system for an electric vehicle, the system comprising:
the electric vehicle comprising an inlet for connecting to an external charger; and
a control unit operable to:
identify a charging control mode based on charging power from the external charger and noise;
generate target power information based on the identified charging control mode; and
transmit the generated target power information to the external charger.

16. The system of claim 15, wherein the electric vehicle to the external charger through a power cable.

17. The system of claim 15, wherein the control unit comprises an identification module configured to identify the charging control mode, and an execution module configured to generate target power based on the charging control mode.

18. The system of claim 15, wherein the charging control mode is identified among a plurality of charging control modes.

19. The system of claim 15, wherein the control unit is configured to:
compare a current noise, a current voltage and a current with a preset reference noise, a preset reference voltage, a preset reference current, respectively, by an identification module;
identify a constant current (CC) control mode, a constant noise (CN) control mode, or a constant voltage (CV) control mode among a plurality of charging control modes based on the comparison, by the identification module; and
generate a reference command based on the identified CC, CN, or CV control mode, by the identification module.

20. A vehicle comprising the charging control system of claim 15.
